(19) United States
(12) Patent Application Publication
(10) Pub. No.: US 2026/0311160 A1
(43) Pub. Date: Oct. 8, 2026

(54) FAST FOOD REORDERING USING A PRINTED RECEIPT HAVING A MACHINE-READABLE OPTICAL CODE

(71) Applicant: Daniel Steck, Stryker, OH (US)

(72) Inventor: Daniel Steck, Stryker, OH (US)

(21) Appl. No.: 19/541,384

(22) Filed: Feb. 16, 2026

Related U.S. Application Data
(60) Provisional application No. 63/783,994, filed on Apr. 5, 2025.

(51) Int. Cl. G06Q 20/32; G06Q 20/20; G06Q 50/12

(52) U.S. Cl. CPC G06Q 20/3276; G06Q 20/209; G06Q 50/12; G06Q 2220/00

(57) ABSTRACT

A system and method for reordering fast food items by reading a machine-readable optical code on a printed receipt to facilitate rapid and accurate order replication. Each order, including item specifics such as quantity, size, and customizations, is encoded into a unique machine-readable optical code delivered to the customer via physical or digital media. The machine-readable optical code, when scanned at a point-of-sale interface, retrieves and processes the order, reducing processing time by 20-48 seconds per transaction and error rates by 8-15%. A menu update mechanism with a configurable grace period ensures compatibility with evolving inventories. The system employs AES-256 encryption for data security and a local cache for fault tolerance, ensuring compliance with data protection regulations and uninterrupted operation. The system is scalable across drive-thru, in-store, and curbside channels, enhancing operational efficiency in fast food establishments.

### CROSS-REFERENCES TO RELATED APPLICATIONS

This invention claims priority to Provisional Patent Application Ser. No. 63/783,994, filed Apr. 5, 2025, and titled “Order Reordering System Using 1D barcode Identifiers for Fast Food Applications”, the entire contents of which is hereby incorporated by reference.

### FIELD OF THE INVENTION

This invention relates generally to fast food ordering systems and methods, and more specifically to systems and methods for reordering previously placed orders.

### BACKGROUND OF THE INVENTION

Fast food operations, including drive-thru ordering and in-store ordering at a counter or kiosk, suffer from inefficiencies in order processing. Industry data indicates an average drive-thru time of 257 seconds per vehicle, with custom orders requiring 60 to 90 seconds for order entry by a human order taker, contributing to delays and reduced revenue. Error rates of 8 to 15% result in annual losses of $50,000 to $100,000 per restaurant, based on $1 million in sales.

Existing solutions, such as mobile apps, accelerate reordering for some users, but exclude approximately 30% of customers unwilling or unable to adopt the use of a mobile app on a smartphone.

1D barcodes printed on receipts, such as taught in U.S. Pat. No. 9,117,231 B2, focus on initial ordering or sales tracking, but not reordering.

### SUMMARY OF THE INVENTION

Unlike existing fast food ordering systems, which focus on initial order placement or require mobile applications for customer interaction, the present invention provides a universal, app-free method for reordering customized fast food items using a printed receipt bearing a machine-readable optical code.

The invention provides a convenient and easy-to-use system that streamlines repeat ordering of custom orders in the context of fast food establishments.

The invention addresses the deficiencies of the prior art by providing a machine-readable optical code-based reordering system adaptable to existing order taking infrastructure, thereby reducing order processing times, increasing revenue, while also enhancing customer satisfaction and accessibility.

The invention provides an app-free method for reordering customized fast food items using machine-readable optical codes on printed receipts.

The invention provides a low-cost system capable of streamlining repeat orders at drive-throughs, at in-store counters, and at in-store kiosks.

The invention includes a system and method for reordering fast food items using unique machine-readable optical code printed on paper receipts. Each order is encoded with attributes that include quantity, size, ingredients, and preparation instructions into machine-readable optical code, such as a UPC or a QR code, delivered to the customer via a printed receipt, digital communication, such as a text or an email, or via an embedded tag (e.g., RFID, or NFC on loyalty cards).

In some embodiments, the machine-readable optical code is integrated directly into the standard customer receipt provided with every transaction, thereby eliminating the need for special or additional slips, and ensuring broad accessibility without extra materials.

The Universal Product Code (UPC or UPC code) is a 1D barcode symbology that is used worldwide for tracking trade items in stores. According to the invention, if the amount of information about the order exceeds the information capacity of a UPC 1D barcode, then a QR code can be used. QR codes have a greater data capacity than the UPC code.

In particular, a standard UPC-A 1D barcode can encode exactly 12 numeric digits. (There is also a compressed UPC-E variant that encodes only 6 digits, but UPC typically refers to UPC-A.)

By contrast, QR codes can encode far more data, depending on the version of the code (Version 1 to 40), error correction level (L, M, Q, or H), and data type. The maximum capacity (at version 40 with the lowest error correction level L) is as follows:

| Data Type | Maximum Capacity |
|---|---|
| Numeric | 7,089 characters |
| Alphanumeric | 4,296 characters |
| Binary/byte | 2,953 bytes |
| Kanji/Kana | 1,817 characters |

Higher error correction levels reduce these capacities to allow for better damage resistance (e.g., up to 30% of the code can be obscured or damaged at level H).

Upon follow-up visits to the fast food restaurant, the customer scans the machine-readable optical code at a drive-thru, kiosk, or counter interface, thereby enabling the point-of-sale (POS) system to retrieve and process the order, reducing baseline times by 20-48 seconds.

A menu update mechanism employs a machine-readable optical code validity period and item-level grace substitution to adapt to item changes. According to the invention, integration of machine-readable optical code-based reordering, along with a menu update mechanism and no-app accessibility, overcomes technical challenges in traditional ordering systems. This combination enables rapid and accurate reordering in a dynamic menu environment, thereby delivering unexpected efficiency gains, such as reducing drive-thru times by 20 to 48 seconds per transaction.

Additional advantages include an average 20% reduction in drive-thru times, 8% to 15% error reduction, and scalability to 200,000+U.S. fast food restaurants (and 856,000 global outlets), thereby enhancing throughput and customer satisfaction, without requiring customers to use a mobile app.

The system can also incorporate AES-256 encryption and a local cache to ensure data security and operational reliability, thereby supporting compliance with data protection regulations and uninterrupted service during network disruptions.

Thus, the invention provides a system and method for reordering fast food items, leveraging a machine-readable optical code printed on a paper receipt to enhance speed, accuracy, and scalability.

A general aspect of the invention is a method for reordering fast food items. The method includes: encoding an order for fast food items having specific attributes as a machine-readable optical code; delivering the machine-readable optical code to a customer as part of a fast food order purchase receipt; presenting the fast food order purchase receipt having the machine-readable optical code at a point-of-sale interface; scanning the machine-readable optical code on the fast food order purchase receipt at the point-of-sale interface to reorder the fast food items in accordance with the specific attributes.

In some embodiments, the method further includes: updating the order by rejecting scans after a machine-readable optical code validity period; and offering item substitutions during a grace interval when encoded items are unavailable.

In some embodiments, the machine-readable optical code validity period is configurable.

In some embodiments, the machine-readable optical code is one of: a 1D barcode, a QR code, a Data Matrix.

In some embodiments, the method further including: before encoding the order, encrypting the order using AES-256 encryption; and storing the encrypted order in a database.

In some embodiments, the specific attributes of the order include: quantity, size, ingredient modifications, and preparation instructions.

In some embodiments, the machine-readable optical code includes no more than 7,068 characters of order data.

In some embodiments, scanning the machine-readable optical code on the fast food order purchase receipt includes: using a local cache during network outages.

In some embodiments, the machine-readable optical code includes a link to the database.

In some embodiments, delivering the machine-readable optical code to a customer as part of a fast food order purchase receipt includes: printing the machine-readable optical code on a printed receipt given to the customer.

In some embodiments, delivering the machine-readable optical code to a customer as part of a fast food order purchase receipt includes: transmitting the machine-readable optical code to the customer via email or MMS.

In some embodiments, scanning the machine-readable optical code occurs at: a drive-thru menu board, an in-store kiosk, an in-store counter using a handheld scanning device, or a curbside pole.

In some embodiments, updating the order includes: offering a substitute for an unavailable item during a configurable grace period following item discontinuation, independent of machine-readable optical code validity.

In some embodiments, the substitute is displayed on a touchscreen or announced via speaker.

In some embodiments, offering a substitute for an unavailable item includes at least one of: automatic substitution and manual substitution options.

In some embodiments, the point-of-sale interface is configured to integrate with an existing system without hardware modification.

In some embodiments, the method further including: maintaining a local cache on the point-of-sale system to store order data temporarily during network outages, wherein the cache is configured to support offline reordering, and is configured to synchronize with a cloud database upon reconnection.

In some embodiments, the method further including: generating a new machine-readable optical code upon order finalization.

In some embodiments, the order data is processed without encrypting using AES-256 encryption, instead using alternative data security measures.

In some embodiments, scanning the machine-readable optical code includes:
executing error recovery protocols configured to detect and resolve failures when scanning machine-readable optical codes using one of: manual code entry; and voice recognition.

In some embodiments, scanning the machine-readable optical code at the point-of-sale interface includes: voice-activated prompts for order confirmation or modification, enabling hands-free operation for customers in drive-thru or in-store settings.

In some embodiments, scanning supports multi-machine-readable optical code scanning to combine multiple prior orders into a single transaction, thereby reducing processing time for group or repeat purchases.

In some embodiments, offering item substitutions during the grace interval when encoded items are unavailable includes: offering automated recommendations based on customer preferences or historical data stored in a database.

In some embodiments, the grace interval is dynamically adjusted based on menu change frequency or restaurant-specific parameters.

In some embodiments, delivering the machine-readable optical code to a customer as part of a fast food order purchase receipt includes: embedding the machine-readable optical code in a loyalty card via RFID or NFC technology, facilitating contactless reordering at compatible interfaces.

In some embodiments, the method further including: analyzing aggregated reorder data to generate insights on customer preferences or inventory trends, without compromising data privacy.

In some embodiments, the point-of-sale interface supports integration with third-party payment systems, enabling seamless transaction completion during reordering.

Another general aspect of the invention is a system for reordering fast food items. This system includes: an encoder configured to encode an order having specific attributes into a unique 1D barcode identifier; an encryptor configured to encrypt the order data using AES-256 encryption to ensure data security; a deliverer configured to deliver the 1D barcode to a customer via a physical or digital medium; a scanner configured to scan the 1D barcode at a point-of-sale interface to retrieve and process the order in 5-10 seconds, using a local cache during network outages; a processor configured to update the order by: rejecting scans after a 1D barcode validity period, and offering item substitutions during a grace interval when encoded items are unavailable; wherein the system reduces order processing time by 20-48 seconds and error rates by 8-15%.

In some embodiments, the specific attributes include quantity, size, ingredient modifications, and preparation instructions.

In some embodiments, the 1D barcode is a QR code embedding at least 7,068 characters of order data.

In some embodiments, the 1D barcode links to a database storing order details, the database being local and/or cloud-based.

In some embodiments, the deliverer includes a printer configured to print the 1D barcode on a thermal receipt.

In some embodiments, the deliverer includes a transmitter configured to transmit the 1D barcode via email or MMS.

In some embodiments, the scanner is located at a drive-thru menu board, in-store kiosk, handheld staff devices, or curbside pole.

In some embodiments, the processor is configured to prompt a substitute for an unavailable item during a configurable grace period (e.g., 60 days) following item discontinuation, independent of 1D barcode validity.

In some embodiments, the prompt is displayed on a touchscreen or announced via speaker.

In some embodiments, the point-of-sale interface integrates with an existing system without hardware modification.

In some embodiments, the system further including: an encryptor configured to encrypt the order data using AES-256 encryption prior to encoding into the 1D barcode identifier and storing in the database, wherein the encryption ensures compliance with data protection regulations and mitigates tampering risks to less than 0.01% probability.

In some embodiments, the system further including: a local cache on the point-of-sale system to store order data temporarily during network outages, wherein the cache supports offline reordering in 5-10 seconds with 99% reliability and synchronizes with a cloud database upon reconnection.

In some embodiments, the unique 1D barcode identifier is generated without encoding the order having specific attributes, using a pre-existing or alternative identifier for reordering, while maintaining the delivery, scanning, and updating functionalities to reduce order processing time by 20-48 seconds and error rates by 8-15%.

In some embodiments, the system further including: a processor configured to implement error recovery protocols that detect and resolve 1D barcode scanning failures through alternative input methods, such as manual code entry or voice recognition, to ensure continuous service.

In some embodiments, the system is configured to be scalable to at least 200,000 U.S. fast food outlets.

In some embodiments, the scanner and processor are configured to provide voice-activated prompts for order confirmation or modification during 1D barcode scanning at the point-of-sale interface, enabling hands-free operation for customers in drive-thru or in-store settings.

In some embodiments, the scanner is configured to support multi-1D barcode scanning to combine multiple prior orders into a single transaction, reducing processing time for group or repeat purchases.

In some embodiments, the processor is configured to offer item substitutions during the grace interval, including automated recommendations based on customer preferences or historical data stored in the database.

In some embodiments, the processor is configured to dynamically adjust the grace interval based on menu change frequency or restaurant-specific parameters, ensuring adaptability to varying operational conditions.

In some embodiments, the deliverer is configured to embed the 1D barcode in a loyalty card via RFID or NFC technology, facilitating contactless reordering at compatible interfaces.

In some embodiments, the system further including: a processor configured to analyze aggregated reorder data to generate insights on customer preferences or inventory trends, without compromising data privacy.

In some embodiments, the deliverer is configured to prioritize digital mediums for 1D barcode delivery to reduce paper usage, supporting environmentally sustainable operations while maintaining app-free accessibility.

In some embodiments, the point-of-sale interface is configured to support integration with third-party payment systems, enabling seamless transaction completion during reordering.

In some embodiments, the system further including: a processor configured to implement error recovery protocols that detect and resolve 1D barcode scanning failures through alternative input methods, such as manual code entry or voice recognition, to ensure continuous service.

### BRIEF DESCRIPTION OF THE DRAWINGS

Many additional features and advantages will become apparent to those skilled in the art upon reading the following description, when considered in conjunction with the accompanying drawings, wherein:

FIG. 1 illustrates a thermal receipt bearing a QR code encoding an order, including an item list.

FIG. 2 depicts a drive-thru POS system for QR code reordering having a QR code scanner for QR code reading, a speaker/microphone for communicating with a customer via voice, and a post for supporting the drive-thru POS system.

FIG. 3 shows a menu update prompt of a previous order for display on a kiosk screen inside or outside a fast food restaurant, offering substitute options during a grace period.

FIG. 4A is a flowchart of the reordering process, including customer interactions, system prompts, and order editing at a point-of-sale interface.

FIG. 4B is a flowchart showing details of the SYSTEM PROMPT for adding orders.

FIG. 4C is a flowchart showing details of the SYSTEM PROMPT for modifying orders.

### DETAILED DESCRIPTION

The following detailed description refers to the accompanying FIGS, which form a part hereof and illustrate specific embodiments of the invention. In the FIGS, like reference numerals refer to like elements throughout the several views. The detailed description that follows is not intended to limit the scope of the invention, which is defined by the appended claims. The drawings are not necessarily to scale, and certain features may be shown in exaggerated form for clarity of illustration.

Reference will now be made in detail to embodiments of the present invention, examples of which are illustrated in the accompanying drawings. Wherever possible, the same reference numbers are used throughout the drawings to refer to the same or like parts.

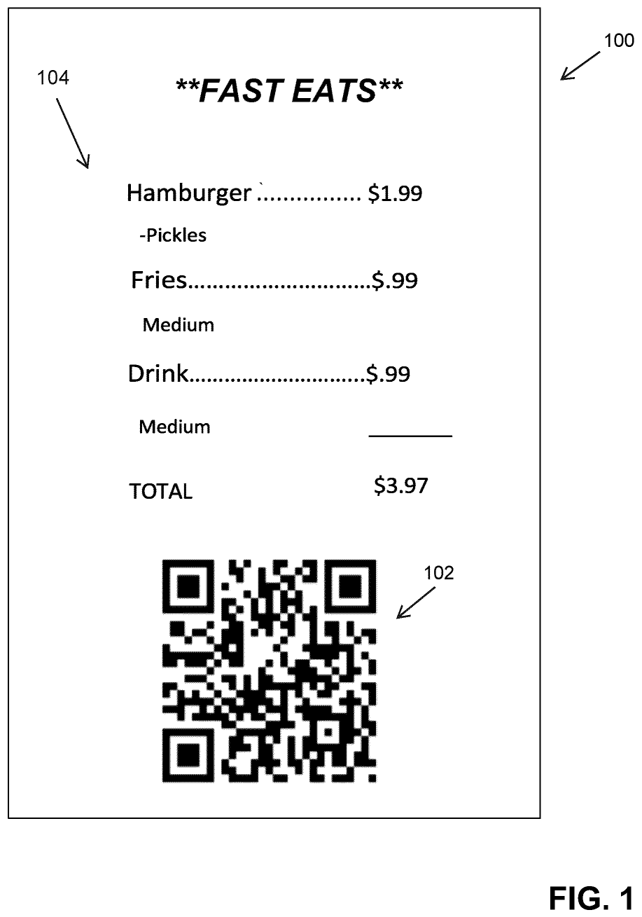

FIG. 1 illustrates an exemplary fast food order purchase receipt 100 according to an embodiment of the present invention. The receipt 100 is, in one embodiment, a thermal receipt printed on standard thermal paper by a thermal printer of the type commonly employed in fast food restaurants. The receipt 100 is delivered to a customer as part of a fast food order purchase transaction and serves as the physical medium by which a machine-readable optical code is delivered to the customer, thereby enabling subsequent reordering of the fast food items without the need for a mobile application.

The receipt 100 includes an item list 104 that enumerates the fast food items ordered by the customer, along with their specific attributes. As shown, the item list 104 includes individual line items (e.g., “Hamburger,” “Fries,” “Drink”), each accompanied by a corresponding price. The specific attributes of the order encoded in the item list 104 may include, without limitation, quantity, size (e.g., “Medium” as shown for the Fries and Drink items), ingredient modifications (e.g., “−Pickles” as shown, indicating removal of pickles from the Hamburger), and preparation instructions. These specific attributes correspond to the order data that is encoded into the machine-readable optical code, as described in greater detail below.

The receipt 100 further includes a machine-readable optical code 102 printed in a lower portion of the receipt 100. In the embodiment shown in FIG. 1, the machine-readable optical code 102 is a QR code. However, it will be appreciated that the machine-readable optical code 102 may alternatively be a 1D barcode (such as a UPC code), a Data Matrix, a PDF417 code, an Aztec Code, or any other suitable machine-readable optical code format, depending on the data capacity requirements of the encoded order. Where the amount of order data exceeds the information capacity of a 1D barcode (e.g., numeric digits for a standard UPC-A), a QR code or other higher-capacity code format may be employed, accommodating up to 7,068 characters of order data in certain embodiments.

The machine-readable optical code 102 encodes the order for the fast food items and their specific attributes, including quantity, size, ingredient modifications, and preparation instructions, so that the encoded order can be retrieved and processed upon a subsequent visit to the fast food restaurant. In some embodiments, the machine-readable optical code 102 encodes the complete order data directly within the code itself (i.e., full embedding). In other embodiments, the machine-readable optical code 102 includes a link to a database, such as a local cache or a cloud database, in which the order details are stored, and the machine-readable optical code 102 serves as a pointer or identifier for retrieving the stored order data. In still further embodiments, a hybrid approach is employed in which the machine-readable optical code 102 embeds certain item names and references customizations stored in the database.

In some embodiments, prior to encoding the order into the machine-readable optical code 102, the order data is encrypted using AES-256 encryption, and the encrypted order is stored in the database. This encryption ensures compliance with data protection regulations and mitigates tampering risks. The machine-readable optical code 102 is further associated with an issuance timestamp and a configurable validity period (e.g., 90 days from purchase), after which scans of the machine-readable optical code are rejected by the point-of-sale system. Upon order finalization at a subsequent visit, a new machine-readable optical code is generated and printed on an updated receipt, resetting the validity period.

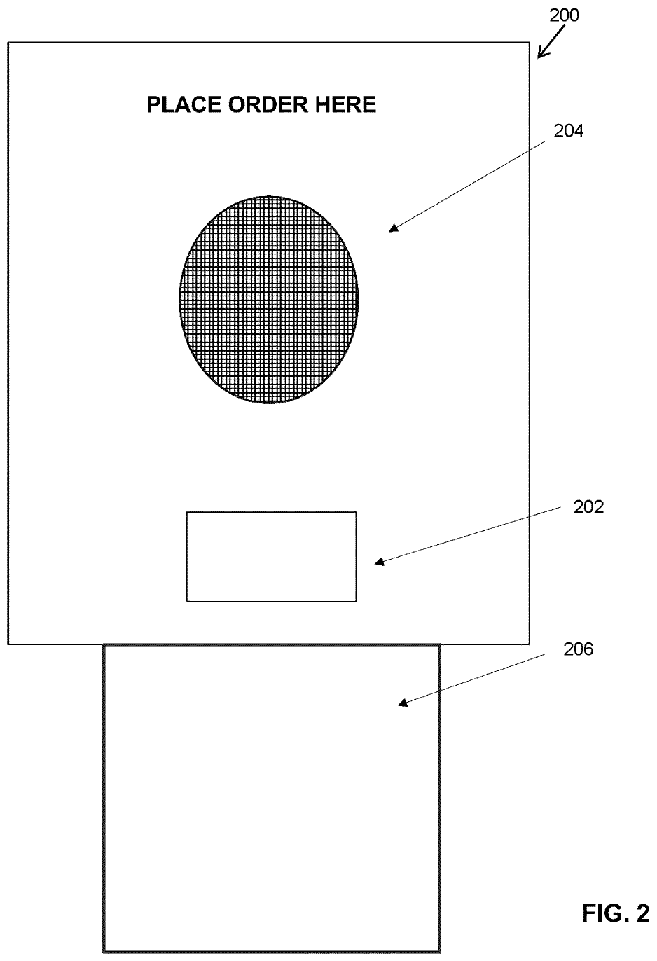

FIG. 2 depicts an exemplary drive-thru point-of-sale (POS) interface 200 configured for machine-readable optical code-based reordering according to an embodiment of the present invention. The drive-thru POS interface 200 is representative of the point-of-sale interface at which a customer presents the fast food order purchase receipt bearing the machine-readable optical code for scanning, as recited in the claims.

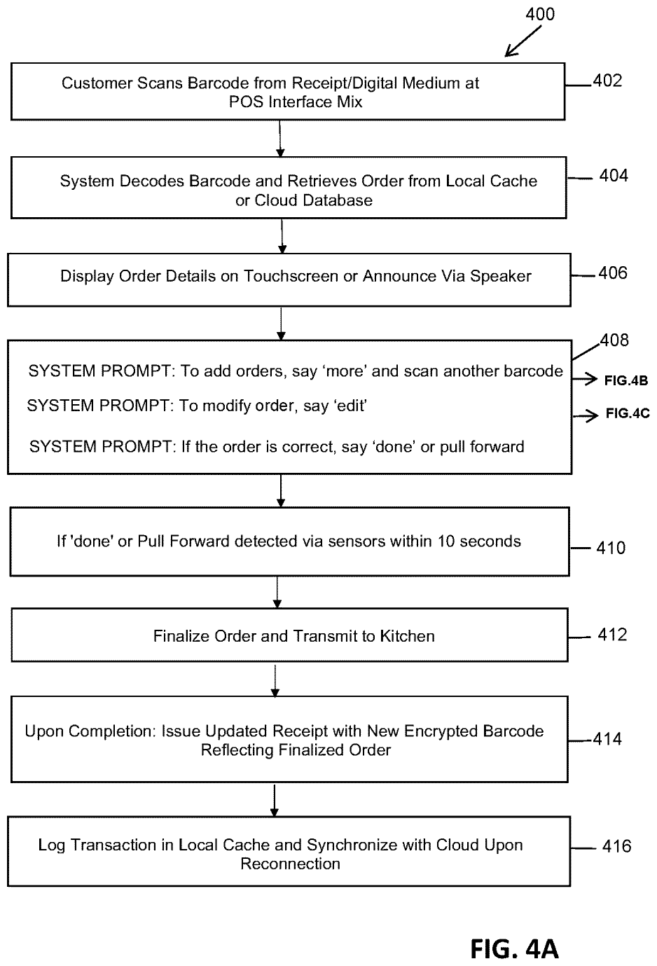

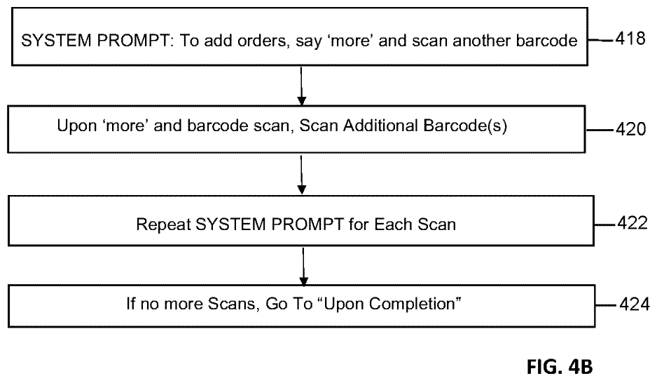

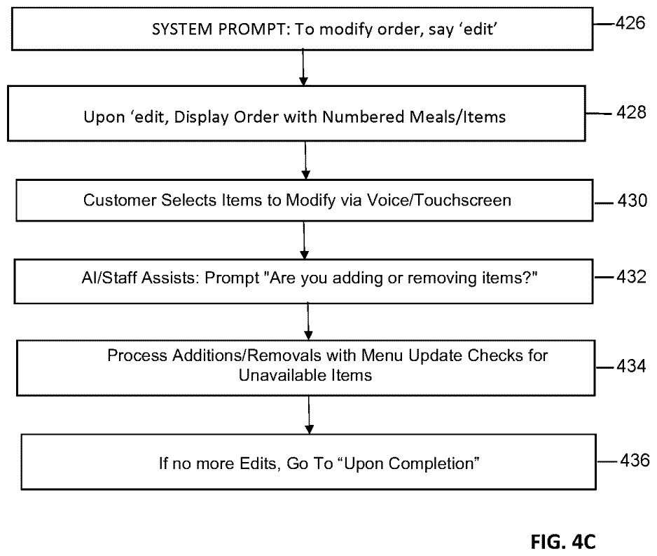

The drive-thru POS interface 200 includes a scanner 202 configured to scan and decode the machine-readable optical code (e.g., the QR code 102 of FIG. 1) presented by the customer on the fast food order purchase receipt. The scanner 202 is positioned at an accessible location on the drive-thru POS interface 200 so that a customer in a vehicle can conveniently present the receipt bearing the machine-readable optical code for scanning. The scanner 202 may include an optical sensor, a camera-based reader, or any other device capable of reading machine-readable optical codes, including 1D barcodes, QR codes, and Data Matrix codes. Upon scanning, the system decodes the machine-readable optical code and retrieves the order from a local cache or a cloud database, as described in connection with FIG. 4A.

The drive-thru POS interface 200 further includes a speaker/microphone 204 for voice-based communication with the customer. The speaker/microphone 204 enables the system to announce order details to the customer and to receive voice commands from the customer for order confirmation or modification. In some embodiments, voice-activated prompts are provided for order confirmation or modification, enabling hands-free operation for customers in the drive-thru setting. For example, the system May announce the retrieved order items via the speaker and prompt the customer to say “done” to confirm, “more” to add additional orders by scanning another machine-readable optical code, or “edit” to modify the order, as described in greater detail in connection with FIG. 4A.

The drive-thru POS interface 200 is supported by a post 206, which is a drive-thru order taking speaker post of the type conventionally deployed at fast food drive-thru lanes. The post 206 positions the scanner 202 and the speaker/microphone 204 at an appropriate height and location for customer interaction from a vehicle. The point-of-sale interface 200 is configured to integrate with an existing POS system (e.g., Oracle) without hardware modification, requiring only minimal software modification to support the machine-readable optical code-based reordering functionality of the present invention.

Although FIG. 2 illustrates a drive-thru embodiment, it will be appreciated that scanning of the machine-readable optical code may alternatively occur at an in-store kiosk, an in-store counter using a handheld scanning device, or a curbside pole, each of which constitutes a point-of-sale interface within the scope of the present invention.

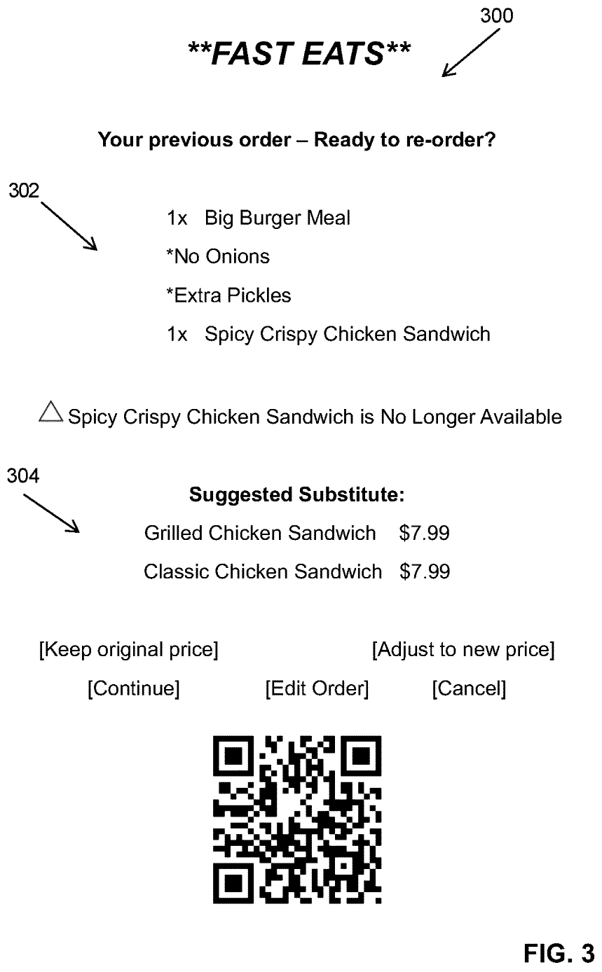

FIG. 3 shows a menu update prompt 300 displayed on a screen of a kiosk, touchscreen display, or other visual output device at a point-of-sale interface, according to an embodiment of the present invention. The menu update prompt 300 is presented to the customer when, upon scanning the machine-readable optical code and decoding the encoded order, the system determines that one or more previously ordered items are no longer available (e.g., discontinued or out of stock).

The menu update prompt 300 displays a previous order 302 that was encoded in the scanned machine-readable optical code. As shown, the previous order 302 includes the previously ordered fast food items and their specific attributes, such as “1× Big Burger Meal” with modifications “*No Onions” and “*Extra Pickles,” and “1× Spicy Crispy Chicken Sandwich.” The display of the previous order 302 allows the customer to review the items that were encoded in the machine-readable optical code and to confirm the order prior to finalization.

The menu update prompt 300 further includes an alert indicating that an item in the previous order 302 is no longer available. As illustrated, the prompt indicates: “Spicy Crispy Chicken Sandwich is No Longer Available.” This alert is generated by the system upon comparing each encoded item in the previous order 302 against the current menu database and determining that the Spicy Crispy Chicken Sandwich has been discontinued or is otherwise unavailable.

In response to the unavailability of the encoded item, the system activates a grace mode and presents substitute options 304 to the customer. The substitute options 304, as shown, include at least one suggested substitute item (e.g., “Grilled Chicken Sandwich $7.99” and “Classic Chicken Sandwich $7.99”). The substitute options 304 are offered during a configurable grace period (e.g., up to 60 days post-discontinuation) following item discontinuation, independent of machine-readable optical code validity. In some embodiments, the substitute options 304 include automated recommendations based on customer preferences or historical data stored in the database.

The menu update prompt 300 additionally presents a plurality of user-selectable action controls. As shown, these controls include: “[Keep original price]” and “[Adjust to new price]” options for pricing of the substitute item; and “[Continue],” “[Edit Order],” and “[Cancel]” options for proceeding with, modifying, or canceling the order, respectively.

The substitute may be displayed on a touchscreen, as illustrated, or announced via the speaker/microphone (e.g., speaker/microphone 204 of FIG. 2), or communicated via text, depending on the specific point-of-sale interface at which the reordering occurs.

At the bottom of the menu update prompt 300, a machine-readable optical code is shown. Upon finalization of the order, including any substitutions or modifications selected by the customer, the system generates a new machine-readable optical code reflecting the finalized order and delivers it to the customer via the receipt or digital medium, thereby resetting the validity period for subsequent reordering.

FIG. 4A is a flowchart illustrating a reordering process 400 according to an embodiment of the present invention. The reordering process 400 depicts the method for reordering fast food items using a machine-readable optical code on a fast food order purchase receipt at a point-of-sale interface.

At step 402, the customer scans a machine-readable optical code from a receipt or other digital medium at a POS interface. The POS interface may be a drive-thru POS interface (such as the drive-thru POS interface 200 of FIG. 2), an in-store kiosk, an in-store counter equipped with a handheld scanning device, or a curbside pole. The customer presents the fast food order purchase receipt having the machine-readable optical code at the point-of-sale interface, and the scanner (such as the scanner 202 of FIG. 2) reads the machine-readable optical code. This step corresponds to the presenting and scanning steps recited in the claims.

At step 404, the system decodes the machine-readable optical code and retrieves the order from a local cache or a cloud database. The system decodes the encoded order data, including the specific attributes of the previously ordered fast food items (e.g., quantity, size, ingredient modifications, and preparation instructions). Where the machine-readable optical code includes a link to the database, the system queries the local cache or cloud database to retrieve the stored order details. Where the order data is encrypted using AES-256 encryption, the system decrypts the data prior to retrieval. The system also checks the machine-readable optical code validity period and rejects scans after the validity period has expired.

At step 406, the system displays the order details on a touchscreen and/or announces the order details via the speaker/microphone (e.g., speaker/microphone 204 of FIG. 2). The display or announcement enables the customer to review the retrieved order items and their specific attributes prior to confirmation.

At step 408, the system issues a series of prompts to the customer. The system prompts include: (1) “To add orders, say ‘more’ and scan another barcode,” which directs the customer to the add-order sub-process detailed in FIG. 4B; (2) “To modify the order, say ‘edit,’” which directs the customer to the order modification sub-process detailed in FIG. 4C; and (3) “If the order is correct, say ‘done’ or pull forward.” These voice-activated prompts enable hands-free operation for customers, particularly in drive-thru settings.

At step 410, if the customer says “done” or pulls forward (detected via sensors within 10 seconds), the system proceeds to finalize the order. The use of vehicle sensors to detect forward movement provides an additional, intuitive confirmation mechanism for drive-thru customers.

At step 412, the system finalizes the order and transmits it to the kitchen for preparation. The finalized order includes all items from the scanned machine-readable optical code(s), along with any modifications or substitutions made by the customer during the reordering process.

At step 414, upon completion, the system issues an updated receipt with a new encrypted machine-readable optical code reflecting the finalized order. The new machine-readable optical code is generated upon order finalization and delivered to the customer, thereby enabling further reordering on a subsequent visit. The new machine-readable optical code carries a fresh issuance timestamp and validity period.

At step 416, the system logs the transaction in a local cache and synchronizes with the cloud database upon reconnection. The local cache on the point-of-sale system stores the order data temporarily during any network outages, supporting offline reordering, and is configured to synchronize with the cloud database upon network reconnection, thereby ensuring fault tolerance and uninterrupted operation.

FIG. 4B is a flowchart illustrating the add-order sub-process referenced at step 408 of FIG. 4A. This sub-process supports multi-machine-readable optical code scanning to combine multiple prior orders into a single transaction, thereby reducing processing time for group or repeat purchases.

At step 418, the system prompts the customer: “To add orders, say ‘more’ and scan another barcode.” This prompt is issued as part of the system prompt at step 408 of FIG. 4A.

At step 420, upon the customer saying “more” and presenting an additional fast food order purchase receipt, the scanner scans the additional machine-readable optical code(s) from the additional receipt(s). The system decodes and retrieves the order data from each additional machine-readable optical code and aggregates the items into the current transaction.

At step 422, the system repeats the system prompt (i.e., returns to step 408 of FIG. 4A) for each additional scan, thereby allowing the customer to continue adding orders from additional machine-readable optical codes as needed.

At step 424, if no more scans are indicated (e.g., the customer says “done” or pulls forward), the process proceeds to the “Upon Completion” steps (steps 414 and 416) of FIG. 4A, where the system issues the updated receipt with a new machine-readable optical code and logs the transaction.

FIG. 4C is a flowchart illustrating the order modification sub-process referenced at step 408 of FIG. 4A. This sub-process enables the customer to edit the retrieved order prior to finalization.

At step 426, the system prompts the customer: “To modify the order, say ‘edit.’” This prompt is issued as part of the system prompt at step 408 of FIG. 4A.

At step 428, upon the customer saying “edit,” the system displays the order with numbered meals and items. The numbered display facilitates identification and selection of specific items to be modified, whether via voice commands or touchscreen input.

At step 430, the customer selects items to modify via voice or touchscreen input. The customer may identify items by their assigned number or by name, depending on the capabilities of the particular point-of-sale interface.

At step 432, an automated AI system or staff member assists the customer by prompting: “Are you adding or removing items?” This prompt guides the customer through the modification process, supporting both additions to and removals from the order.

At step 434, the system processes the requested additions or removals. During this step, the system performs menu update checks for unavailable items. If any requested addition is no longer available (e.g., discontinued or out of stock), the system activates the grace substitution mechanism described in connection with FIG. 3, offering substitute options to the customer during the configurable grace period following item discontinuation.

At step 436, if no more edits are indicated, the process proceeds to the “Upon Completion” steps (steps 414 and 416) of FIG. 4A, where the system finalizes the order, issues the updated receipt with a new machine-readable optical code reflecting the finalized order, and logs the transaction in the local cache for synchronization with the cloud database upon reconnection.

The following sections provide additional implementation details that supplement the foregoing description of the drawings, including pseudocode for menu adaptation logic, error handling mechanisms, security measures, fault tolerance, scalability considerations, and alternative machine-readable optical code formats.

For POS integration with existing systems (e.g., Oracle) without hardware modification, the following pseudocode illustrates the menu adaptation logic:

```
text
if current_date > valid_until:
  reject(“1D barcode expired. Please place new order.”)
else:
  for item in order_items:
    if not menu.contains(item):
      trigger_grace_substitution(item) # Offer substitutes during grace period
```

Error Handling: The system includes mechanisms to manage common machine-readable optical code issues for uninterrupted operation. For damaged or unreadable machine-readable optical code (e.g., due to wear, smudges, or partial obscuration), the POS interface triggers a “manual re-entry” alert, notifying staff via visual display, audible signal, or notification to a handheld device, allowing for immediate order reconstruction through voice or touchscreen input.

In cases of duplicate machine-readable optical codes (e.g., arising from system glitches or concurrent order processing), the POS automatically detects conflicts and regenerates a unique machine-readable optical code, ensuring data integrity without user intervention. These features maintain high reliability, with error recovery typically completed in under 10 seconds, supporting compliance with operational standards and minimizing revenue loss during peak hours.

Security Measures: The system employs AES-256 encryption to secure order data encoded in a machine-readable optical code, and stored in the database, ensuring compliance with data protection regulations such as GDPR and CCPA. Encryption is applied to both physical (e.g., receipt-based machine-readable optical codes) and digital (e.g., email, MMS) delivery methods, with key rotation performed quarterly to mitigate tampering risks (less than 0.01% probability). This safeguards customer privacy, and enhances trust in the system's scalability across large-scale deployments, such as 200,000+ U.S. fast food outlets or 856,000 global fast food outlets.
Fault Tolerance: To ensure uninterrupted operation during network disruptions (e.g., cloud service outages, less than 0.1% probability), the system incorporates a local cache mechanism. This cache, implemented on the POS system, stores order data temporarily and processes reordering requests offline, automatically synchronizing with the cloud database upon reconnection. The local cache supports up to 1,000 orders per day per store, maintaining 99% scan reliability and 5 to 10 second reordering times, critical for high-traffic environments such as drive-thrus handling 80 to 180 additional orders daily.

Scalability: Applicable to single-brand (e.g., 14,000 McDonald's stores) or multi-brand operations (e.g., 200,000+U.S. outlets), across drive-thru, in-store, and curbside channels.

### Examples

A McDonald's store reduces drive-thru time from 257 s to between 237 s and 209 s, saving 20 s to 48 s per car.
A partial adoption scenario saves 30 s for 10% of customers with complex orders, yielding 3 s average reduction.

The machine-readable optical codes can be 1D barcodes, QR codes, or can be one of:
Data Matrix: A 2D matrix code that stores data in a grid of black and white cells, similar to QR codes, but more compact for small spaces. It can hold up to 2,335 alphanumeric characters and is often used for labeling small items.
PDF417: A stacked linear 1D barcode (essentially a 2D version of 1D barcodes) that can store large amounts of data, like up to 1,850 alphanumeric characters.
Aztec Code: A 2D code with a bullseye pattern for easy centering during scans. It supports high data density (up to 3,832 numeric characters) and error correction.
MaxiCode: A hexagonal 2D code designed for high-speed sorting, holding about 93 characters.
SnapTags: Customizable visual tags (e.g., with images or colors) that encode data such as URLs or text. They can make menu representations more branded and engaging, such as embedding a restaurant logo that scans to reveal item options.

Thus, a machine-readable optical code is a visual symbol, such as a barcode, QR code, or data matrix, engineered to be quickly and accurately read by a scanner or digital sensor rather than a human. These codes encode information in a format (using patterns of lines, dots, or geometric shapes) that can be optically scanned and processed into digital data, allowing for automated identification, tracking, or data entry.

Other modifications and implementations will occur to those skilled in the art without departing from the spirit and the scope of the invention as claimed. Accordingly, the above description is not intended to limit the invention, except as indicated in the following claims.

What is claimed is:

1. A method for reordering fast food items, the method comprising:
encoding an order for fast food items having specific attributes as a machine-readable optical code;
delivering the machine-readable optical code to a customer as part of a fast food order purchase receipt;
presenting the fast food order purchase receipt having the machine-readable optical code at a point-of-sale interface;
scanning the machine-readable optical code on the fast food order purchase receipt at the point-of-sale interface to reorder the fast food items in accordance with the specific attributes.

2. The method of claim 1, further comprising:
updating the order by:
rejecting scans after a machine-readable optical code validity period; and
offering item substitutions during a grace interval when encoded items are unavailable.

3. The method of claim 2, wherein the machine-readable optical code validity period is configurable.

4. The method of claim 1, wherein the machine-readable optical code is one of:
a 1D barcode, a QR code, a Data Matrix.

5. The method of claim 1, further comprising:
before encoding the order, encrypting the order using AES-256 encryption; and
storing the encrypted order in a database.

6. The method of claim 1, wherein the specific attributes of the order include:
quantity, size, ingredient modifications, and preparation instructions.

7. The method of claim 1, wherein the machine-readable optical code includes no more than 7,068 characters of order data.

8. The method of claim 1, wherein scanning the machine-readable optical code on the fast food order purchase receipt includes:
using a local cache during network outages.

9. The method of claim 1, wherein the machine-readable optical code includes a link to the database.

10. The method of claim 1, wherein delivering the machine-readable optical code to a customer as part of a fast food order purchase receipt includes:
printing the machine-readable optical code on a printed receipt given to the customer.

11. The method of claim 1, wherein delivering the machine-readable optical code to a customer as part of a fast food order purchase receipt includes:
transmitting the machine-readable optical code to the customer via email or MMS.

12. The method of claim 1, wherein scanning the machine-readable optical code occurs at:
a drive-thru menu board, an in-store kiosk, an in-store counter using a handheld scanning device, or a curbside pole.

13. The method of claim 1, wherein updating the order includes:
offering a substitute for an unavailable item during a configurable grace period following item discontinuation, independent of machine-readable optical code validity.

14. The method of claim 13, wherein the substitute is displayed on a touchscreen or announced via speaker.

15. The method of claim 13, wherein offering a substitute for an unavailable item includes at least one of:
automatic substitution and manual substitution options.

16. The method of claim 1, wherein the point-of-sale interface is configured to integrate with an existing system without hardware modification.

17. The method of claim 1, further comprising:
maintaining a local cache on the point-of-sale system to store order data temporarily during network outages, wherein the cache is configured to support offline reordering, and is configured to synchronize with a cloud database upon reconnection.

18. The method of claim 1, further comprising:
generating a new machine-readable optical code upon order finalization.

19. The method of claim 5, wherein the order data is processed without encrypting using AES-256 encryption, instead using alternative data security measures.

20. The method of claim 1, wherein scanning the machine-readable optical code includes:
executing error recovery protocols configured to detect and resolve failures when scanning machine-readable optical codes using one of: manual code entry; and
voice recognition.
